(19) United States
(12) Patent Application Publication
(10) Pub. No.: US 2022/0034392 A1
(43) Pub. Date: Feb. 3, 2022

(54) Strain wave gear and elastic transmission element therefor, robotic arm and method for arranging a strain gauge

(71) Applicant: Schaeffler Technologies AG & Co. KG, Herzogenaurach (DE)

(72) Inventors: Jochen Damerau, Tokyo (JP); Jens Heim, Bergrheinfeld (DE)

(73) Assignee: Schaeffler Technologies AG & Co. KG, Herzogenaurach (DE)

(21) Appl. No.: 17/280,367

(22) PCT Filed: Sep. 24, 2019
(86) PCT No.: PCT/DE2019/100836

§ 371 Date: Mar. 26, 2021

(30) Foreign Application Priority Data
Oct. 10, 2018 (DE) 10 2018 125 078.9

(51) Int. Cl. F16H 49/00; G01L 1/22; G01L 3/14; G01M 13/021

(52) U.S. Cl. CPC F16H 49/001; G01L 1/2231; F16H 2049/003; G01M 13/021; G01L 3/1457

(57) ABSTRACT

An elastic transmission element is used in a strain wave gear. Such strain wave gears are also referred to as Harmonic Drives. The elastic transmission element is also referred to as a flexspline. Outer toothing is formed on the elastic transmission element. Furthermore, at least one strain gauge for measuring a mechanical strain of the elastic transmission element is arranged on the elastic transmission element. The at least one strain gauge is formed as a coating directly on a metallic surface of the elastic transmission element.

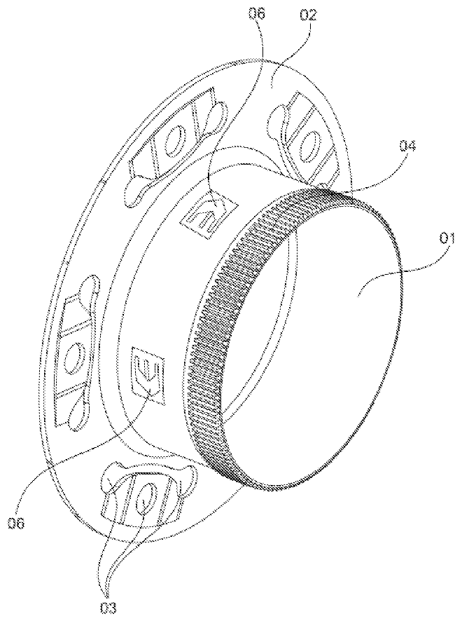

### CROSS-REFERENCE TO RELATED APPLICATIONS

This application is the U.S. National Phase of PCT Appln. No. PCT/DE2019/100836 filed Sep. 24, 2019, which claims priority to DE 10 2018 125 078.9 filed Oct. 10, 2018, the entire disclosures of which are incorporated by reference herein.

### TECHNICAL FIELD

The present disclosure first relates to an elastic transmission element of a strain wave gear. Such strain wave gears are also referred to as Harmonic Drives or harmonic gearing. The elastic transmission element is also referred to as a flexspline. The elastic transmission element has at least one strain gauge for measuring a mechanical strain of the elastic transmission element. The disclosure further relates to a strain wave gear, a robotic arm, and a method for arranging a strain gauge on an elastic transmission element of a strain wave gear.

### BACKGROUND

The article by Hashimoto, M., et al., “A joint torque sensing technique for robots with harmonic drives” in Proceedings of IEEE International Conference on Robotics and Automation, Issue 2, pages 1034-1039, April 1991, describes a method for measuring a torque in a strain wave gear. Strain gauges which are arranged on an elastic transmission element of the strain wave gear are used for measurement.

The article by Taghirad, Hamid D. et al., “Intelligent built-in torque sensor for harmonic drive systems” in Proceedings of IEEE Instrumentation and Measurement Technology Conference Sensing, Processing, Networking, May 1997, and the dissertation by Taghirad, Hamid D., “Robust torque control of harmonic drive systems”, Department of Electrical Engineering. McGill University, Montreal, 1997, show a torque sensor for measuring a torque in a strain wave gear. A Kalman filter is used to eliminate high-frequency measurement signal components.

DE 10 2004 041 394 A1 discloses a wave gear device with a torque detection mechanism which comprises a plurality of strain gauges with resistance wire regions on a flexible outer gearwheel, which are electrically connected via conducting wires.

JP 2000320622 A discloses a wave gear having a torque sensor mechanism, which comprises a strain gauge, on a flexible outer gearwheel, which is electrically connected via conducting wires.

US 2004/0079174 A1 teaches a torque detection apparatus for a wave gear comprising a strain gauge unit which has a strain gauge pattern. The strain gauge pattern comprises arc-shaped detection segments A and B and three terminal portions for external wiring, one of which is formed between the detection segments and the others of which are formed at the opposite ends thereof.

JP 2016-045055 A discloses the use of a Wheatstone bridge with a strain gauge on a rotating shaft of a wave gear.

U.S. Pat. No. 6,840,118 B2 discloses a torque-measuring method for measuring a torque transmitted in a wave gear device. In the strain-wave gearing device, a flexible, annular external gear is partially meshed with a rigid internal gear. A plurality of strain gauge sets is attached to the surface of the flexible outer gearwheel.

CN 105698992 A relates to a high-precision wave gear having a built-in torque sensor. The torque sensor comprises, inter alia, a Wheatstone half bridge.

RU 2 615 719 C1 teaches a wave gear which is designed to measure a torque.

WO 2010/142318 A1 discloses a device for measuring a torque in a wave gear. The device comprises at least one sensor for measuring forces between an outer ring with inner toothing and a housing.

JP 6320885 B2 describes a torque detection element which comprises a plurality of strain gauges that form a Wheatstone bridge. The strain gauges are arranged in the form of a pattern-like metallic film on a surface of a flexible film-like insulation.

### SUMMARY

It is desirable to enable measurement of a mechanical stress in a strain wave gear more precisely and more reliably.

The elastic transmission element forms a torque-transmitting component of a strain wave gear. The strain wave gear can also be referred to as Harmonic Drive or harmonic gearing. The elastic transmission element can also be referred to as a flexspline. The elastic transmission element is preferably designed to derive a torque to be transmitted by the strain wave gear.

The elastic transmission element has an outer toothing which is designed to engage an inner toothing of a rigid outer ring of the strain wave gear. The outer toothing and the inner toothing differ in their number of teeth—the difference being preferably two.

The elastic transmission element is equipped with at least one strain gauge and is used to measure a mechanical strain of the elastic transmission element. The at least one strain gauge is preferably used to measure a torque acting on the elastic transmission element.

The at least one strain gauge is formed as a coating directly on a metallic surface of the elastic transmission element. The coating is firmly applied to the metallic surface. The at least one strain gauge is thus arranged and fastened on the metallic surface of the elastic transmission element without an intermediate layer, in particular without an adhesive. There is a direct bond between the at least one strain gauge and the metallic surface of the elastic transmission element.

A particular advantage of the transmission element is that a precise arrangement of the at least one strain gauge is guaranteed without the need for an additional expenditure. The solutions known from the prior art, which provide for fastening the strain gauges with the aid of an adhesive, require a great deal of effort for the precise positioning of the strain gauges on the elastic transmission element. It can easily lead to an inaccurate positioning, which leads to inaccurate measurement results or an increased calibration effort. In addition, an attachment using adhesive is not completely rigid and the strain gauges might shift slightly over the course of the operating time, which can shift a calibration point of the strain gauges. In addition, an aging of the adhesive has negative effects on the calibration and the behavior of the sensor. Different temperatures can also affect the adhesive bond and cause a minimal displacement of the strain gauges. The disclosed transmission element therefore also has improved long-term stability, and minimal displacements of the strain gauge are also excluded. Another advantage of the disclosed transmission element compared to the solutions known from the prior art with an adhesive connection is that the at least one strain gauge can be arranged in a space-saving manner due to the direct arrangement on the metallic surface of the elastic transmission element, whereas an adhesive connection leads to a larger space requirement. Correspondingly, the disclosed elastic transmission element allows the strain gauges to be better integrated into the strain wave gear.

In preferred embodiments of the elastic transmission element, the at least one strain gauge forms a component of a torque sensor. The torque sensor is used to measure a torque acting on the elastic transmission element. The at least one strain gauge is connected to a measurement signal processing unit of the torque sensor via electrical connections. The measurement signal processing unit preferably comprises measurement signal amplifiers, measurement signal addition units, measurement signal inverters, analog filters, digital filters, AD converters, a microprocessor and data memory.

In preferred embodiments of the elastic transmission element, the at least one strain gauge comprises an electrically insulating layer which is formed as a coating directly on the metallic surface of the elastic transmission element. There is preferably a direct material bond between the electrically insulating layer and the metallic surface of the elastic transmission element. The strain gauge preferably further comprises an electrical measuring grid layer which is applied as a coating directly to the electrically insulating layer. The strain gauge preferably exclusively comprises the electrically insulating layer and the electrical measuring grid layer as layers.

The electrically insulating layer preferably consists of a polyimide, such as Kapton, or a glass.

In preferred embodiments of the elastic transmission element, the at least one strain gauge is applied directly to the metallic surface of the elastic transmission element by a sputter deposition. For this purpose, the electrically insulating layer is preferably applied to the metallic surface of the elastic transmission element and an electrical resistance layer is applied to the electrically insulating layer, wherein the electrical measuring grid layer is then laser-structured from the electrical resistance layer. The strain gauge applied by sputter deposition is seated firmly and permanently on the metallic surface of the elastic transmission element. Alternatively, the at least one strain gauge is preferably printed directly onto the metallic surface of the elastic transmission element, wherein the electrically insulating layer is preferably first printed onto the metallic surface of the elastic transmission element and then the electrical measuring grid layer is printed onto the electrically insulating layer.

The elastic transmission element preferably has a bushing-shaped portion in the form of a sleeve on which the external toothing is formed. The bushing-shaped portion consists of a metal which forms the metallic surface of the elastic transmission element. The at least one strain gauge is preferably arranged on the bushing-shaped portion. For this purpose, the at least one strain gauge is formed as a coating directly on the metallic surface of the bushing-shaped portion of the elastic transmission element.

The elastic transmission element preferably has the shape of a bowl, which is also referred to as a cup shape.

The elastic transmission element preferably further comprises an annular or disk-shaped portion adjoining the bushing-shaped portion in the axial direction. The annular portion preferably has the shape of a collar or a flange. Correspondingly, the elastic transmission element has the shape of a flanged sleeve. The annular portion is used to couple a shaft to the transmission element to transmit a torque to the shaft. The bushing-shaped portion and the annular or disk-shaped portion have a common axis.

The elastic transmission element preferably has the shape of a top hat, which is also referred to as a silk hat shape. This embodiment is suitable for coupling a larger hollow shaft to the transmission element to transmit a torque to the hollow shaft. The hollow shaft preferably forms a component of a robot.

The at least one strain gauge is preferably arranged on the annular portion of the elastic transmission element. For this purpose, the at least one strain gauge is formed as a coating directly on the metallic surface of the annular portion on an axial side surface of the elastic transmission element.

In preferred embodiments of the elastic transmission element, a plurality of the strain gauges are each formed as a coating directly on the metallic surface of the elastic transmission element. The plurality of strain gauges are preferably arranged circumferentially around the elastic transmission element. The plurality of strain gauges are preferably distributed circumferentially on the bushing-shaped portion or on the annular portion of the elastic transmission element. This arrangement enables certain negative influences on the measurement signal to be avoided.

In preferred embodiments of the elastic transmission element, the plurality of strain gauges form a Wheatstone bridge.

The strain wave gear has a wave generator which comprises a non-annular disk and preferably a deformable raceway. The non-annular disk has a non-annular cross-section. The non-annular disk preferably has an elliptical, oval, or resal-curve-shaped cross-section. The non-annular disk is preferably made of steel and preferably forms a drive for the strain wave gear. The strain wave gear also comprises a rigid outer ring with an inner teething. The outer ring is preferably formed as a hollow cylinder and is also referred to as a circular spline. The strain wave gear also comprises the elastic transmission element. Rolling bodies of a wave generator bearing are preferably located between the non-annular disk and the elastic transmission element.

The strain wave gear preferably comprises one of the described preferred embodiments of the elastic transmission element. In addition, the strain wave gear preferably also has features that are described in connection with the transmission element.

The robotic arm comprises at least one drivable arm element which is coupled via the strain wave gear. The at least one drivable arm element is preferably coupled via one of the described preferred embodiments of the strain wave gear.

The method is used to arrange a strain gauge on an elastic transmission element of a strain wave gear. Outer toothing is formed on the elastic transmission element. According to the method, the strain gauge is applied as a coating directly to a metallic surface of the elastic transmission element. Preferably, an electrically insulating layer of the strain gauge is first applied directly to the metallic surface of the elastic transmission element. Subsequently, an electrical measuring grid layer of the strain gauge is preferably applied directly to the electrically insulating layer.

The method is preferably used to form the elastic transmission element. The method preferably also has features that are described in connection with the elastic transmission element.

### BRIEF DESCRIPTION OF THE DRAWINGS

Further advantages, details and developments of the elastic transmission element will become apparent from the following description of a preferred embodiment, with reference to the accompanying drawings. The single FIGURE is a pictorial view of an elastic transmission element for use in a strain wave gear.

### DETAILED DESCRIPTION

The single FIGURE shows a preferred embodiment of an elastic transmission element of a strain wave gear. The elastic transmission element, which is also referred to as a flexspline, has a bushing-shaped portion 01, to which an annular portion 02 is connected. The annular portion 02 forms a flange and has a plurality of fastening holes 03 for fastening a shaft (not shown) to which a torque is transmitted by the strain wave gear. On the bushing-shaped portion 01, an external toothing 04 is formed, which engages in an internal toothing (not shown) of an outer ring of the strain wave gear.

Four strain gauges 06 are also arranged on the bushing-shaped portion 01 of the elastic transmission element. The elastic transmission element consists of a metal, wherein the strain gauges 06 are applied as a coating directly to the metallic surface of the elastic transmission element.

The four strain gauges 06 are circumferentially evenly distributed on the circumference of the bushing-shaped portion 01 of the elastic transmission element and form a Wheatstone bridge.

### LIST OF REFERENCE SIGNS

01 Bushing-shaped portion
02 Annular portion
03 Fastening holes
04 Outer toothing
-
06 Strain gauge

1. An elastic transmission element of a strain wave gear, wherein an outer toothing is formed on the elastic transmission element, and wherein at least one strain gauge for measuring a mechanical strain of the elastic transmission element is arranged on the elastic transmission element, wherein the at least one strain gauge is formed as a coating directly on a metallic surface of the elastic transmission element.

2. The elastic transmission element according to claim 1, wherein the at least one strain gauge has formed a direct integral connection with the metallic surface of the elastic transmission element.

3. The elastic transmission element according to claim 1, wherein the at least one strain gauge forms a component of a torque sensor and is connected to a measurement signal processing unit of the torque sensor via electrical connections.

4. The elastic transmission element according to claim 1, wherein the at least one strain gauge comprises an electrically insulating layer which is formed as a coating directly on the metallic surface of the elastic transmission element.

5. The elastic transmission element according to claim 1, wherein the at least one strain gauge is applied directly to the metallic surface of the elastic transmission element by a sputter deposition.

6. The elastic transmission element according to claim 1, wherein it has a bushing-shaped portion on which the outer toothing is formed and on which the at least one strain gauge is arranged, wherein the at least one strain gauge is formed as a coating directly on the metallic surface of the bushing-shaped portion of the elastic transmission element.

7. The elastic transmission element according to claim 1, wherein a plurality of the strain gauges are each formed as a coating directly on the metallic surface of the elastic transmission element, which are distributed circumferentially around the elastic transmission element.

8. A strain wave gear having a wave generator comprising a non-annular disk, a rigid outer ring having internal toothing and an elastic transmission element according to claim 1.

9. A robotic arm having at least one drivable arm element which is coupled via a strain wave gear according to claim 8.

10. A method for arranging a strain gauge on an elastic transmission element of a strain wave gear, wherein an outer toothing is formed on the elastic transmission element, and wherein the strain gauge is applied as a coating directly to a metallic surface of the elastic transmission element.

11. A transmission element of a strain wave gear, the transmission element comprising:
an annular flange portion adapted for fixation to a shaft;
an elastic bushing-shaped portion fixed at a first axial end to the flange portion and having external toothing formed at a second axial end opposite the first axial end; and
a plurality of strain sensors formed as a coating on the bushing-shaped portion and circumferentially spaced from one another.

12. The transmission element of claim 11, wherein the bushing-shaped portion is metal.

13. The transmission element of claim 11, wherein the plurality of sensors are equally spaced around a perimeter of the bushing-shaped portion.

14. The transmission element of claim 11, wherein the plurality of sensors form a Wheatstone bridge.
